(19) United States
(12) Patent Application Publication
(10) Pub. No.: US 2025/0111530 A1
(43) Pub. Date: Apr. 3, 2025

(54) FISHEYE IMAGE PROCESSING METHOD, ELECTRONIC DEVICE, AND COMPUTER-READABLE STORAGE MEDIUM

(71) Applicant: Shenzhen Reolink Technology Co., Ltd., Shenzhen (CN)

(72) Inventors: Xiaoyu Liu, Shenzhen (CN); Sheng Yong, Shenzhen (CN); Xuezheng Yang, Shenzhen (CN)

(21) Appl. No.: 18/978,253

(22) Filed: Dec. 12, 2024

Related U.S. Application Data
(63) Continuation-in-part of application No. PCT/CN2024/078833, filed on Feb. 27, 2024.

(30) Foreign Application Priority Data
Feb. 28, 2023 (CN) 202310232011.1

(51) Int. Cl. G06T 7/62; G06F 17/11

(52) U.S. Cl. CPC G06T 7/62; G06F 17/11

(57) ABSTRACT

This application provides a fisheye image processing method, an electronic device, and a computer-readable storage medium. The fisheye method includes: extracting n sampling points in a fisheye image shot by a fisheye camera; determining n sampling points of a fisheye image; determining Cₙ³ sets of sampling points and corresponding circles; calculating errors of the sets of sampling points; calculating a first accumulated value of the errors and a second accumulated value of the errors of the sets of sampling points; constructing a nonlinear optimization equation; and determining an effective imaging area of the fisheye camera according to the nonlinear optimization equation. The anti-distortion correction for the fisheye camera is performed in the process of shooting images according to the effective imaging area of the fisheye camera.

### CROSS-REFERENCE TO RELATED APPLICATIONS

This application is a continuation of International Application No. PCT/CN2024/078833, filed on Feb. 27, 2024, which claims priority to Chinese Patent Application No. 202310232011.1, filed on Feb. 28, 2023. The disclosures of the aforementioned applications are hereby incorporated by reference in their entireties.

### TECHNICAL FIELD

This application relates to the technical field of fisheye image processing, and more particularly relates to a fisheye image processing method, an electronic device, and a computer-readable storage medium.

### BACKGROUND

In the process of anti-distortion correction for a fisheye camera, it is necessary to accurately determine an effective imaging area and an optical center to ensure a correction effect. In general, accurate calibration will be performed before delivery. However, in the process of using the fisheye camera, in the case where displacement of a structure of the fisheye camera is caused by a collision, and the like, the effective imaging area may change, and it is necessary to recalibrate the effective imaging area. After delivery, recalibration and using environments are more complicated than a production environment, resulting in a lower accuracy of the effective imaging area determined based on an image collected by the fisheye camera after delivery. Therefore, a method with relatively strong robustness is urgently needed to accurately detect the effective imaging area.

### SUMMARY

This application provides a fisheye image processing method, an electronic device, and a computer-readable storage medium.

In a first aspect, this application provides a fisheye image processing method. The method includes: extracting n sampling points in a fisheye image shot by a fisheye camera; randomly selecting 3 sampling points from the n sampling points to obtain Cₙ³ sets of sampling points, and determining a circle corresponding to each set of sampling points; for any one set of sampling points in the Cₙ³ sets of sampling points, calculating a sum of distances from the n sampling points to the circle corresponding to the set of sampling points as an error of the set of sampling points; calculating a first accumulated value of the errors of the Cₙ³ sets of sampling points, and for any one sampling point p in the n sampling points, calculating a second accumulated value of the errors of all sets of sampling points containing the point p; calculating a weight coefficient of the point p according to the first accumulated value and the second accumulated value, the weight coefficient having a negative correlation with the second accumulated value; and constructing a nonlinear optimization equation according to the weight coefficient, and determining an effective imaging area of the fisheye camera according to the nonlinear optimization equation.

Optionally, the fisheye image processing method further includes: acquiring an original image shot by the fisheye camera; and preprocessing the original image to obtain the fisheye image, the preprocessing including edge detection and image binarization.

Optionally, the original image is preprocessed by performing downsampling on the original image; and preprocessing the downsampled original image to obtain the fisheye image.

Optionally, the weight coefficient of the point p is calculated by the following formula: W_{P}=1−ΣF_{P}/ΣF, wherein W_{P} is the weight coefficient of the point p, ΣF is the first accumulated value, and ΣF_{P} is the second accumulated value.

Optionally, the nonlinear optimization equation is constructed according to the following formula: C(x, y, R)=Σ_{P=1}ⁿW_{P}*[(x_{P}−x)²+(y_{P}−y)²−R²], wherein (x_{P}, y_{P}) is an image coordinate of the point p, (x, y) is an image coordinate of a center of circle of the effective imaging area, W_{P} is the weight coefficient of the point p, and R is a radius of the effective imaging area.

Optionally, the effective imaging area of the fisheye camera is determined by means of: taking a partial derivative of x in the nonlinear optimization equation to obtain a first equation; taking a partial derivative of y in the nonlinear optimization equation to obtain a second equation; taking a partial derivative of R in the nonlinear optimization equation to obtain a third equation; getting values of x, y and R by a preset step length according to the first equation, the second equation, the third equation and a preset gradient descent algorithm to obtain a plurality of sets of numerical values, and calculating a function value of the nonlinear optimization equation corresponding to each set of numerical values; and determining the effective imaging area according to the numerical value corresponding to the minimum function value.

Optionally, the fisheye image processing method further includes: extracting m sampling points having distances from the center of circle of the effective imaging area located within a preset distance range; and reconstructing the nonlinear optimization equation according to weight coefficients corresponding to the m sampling points, and updating the effective imaging area according to the reconstructed nonlinear optimization equation.

In a second aspect, this application further provides an electronic device which includes: a memory configured to store a plurality of computer-readable instructions; one or more processors coupled to the memory and configured to execute the computer-readable instructions to perform the fisheye image processing method described above.

In a third aspect, this application further provides a non-transitory computer-readable storage medium containing a plurality of computer-readable instructions stored thereon, when the computer-readable instructions are executed by a processor of the electronic device, causes the processor to execute the fisheye image processing method described above.

For the fisheye image processing method, a fisheye image processing apparatus, the electronic device, and the computer-readable storage medium according to the embodiments of this application, by extracting n sampling points in the fisheye image, and then taking any 3 sampling points in the n sampling points as a set, Cₙ³ sets of sampling points are determined, and a circle corresponding to each set of sampling points is determined; an error corresponding to each set of sampling points may be determined by calculating a sum of distances from the n sampling points to the circle corresponding to each set of sampling points; and then by determining a first accumulated value of the errors of the Cₙ³ sets of sampling points, and a second accumulated value of the errors of all sets of sampling points containing any one sampling point p in the n sampling points, a weight coefficient of any one sampling point p is determined. It can be understood that the farther one sampling point is from other sampling points, the greater the possibility that the sampling point is noise is, therefore the greater the second accumulated value of the sampling point p is, the farther the sampling point p is from other sampling points, and the smaller the weight coefficient of the sampling point p is. By determining the weight coefficient of any one sampling point p in advance, the influence of the sampling point which may be noise in the fisheye image is reduced, and thus the nonlinear optimization equation for determining the effective imaging area of the fisheye image is constructed based on the weight coefficient of each sampling point, and the effective imaging area of the fisheye image may be accurately obtained by calculating the optimal solution for the nonlinear optimization equation. In this way, compared with the case where it is difficult to accurately screen target sampling points which can be used for accurately calculating the effective imaging area in all the sampling points in different scenes, in this application, the sampling points do not need to be screened, only the weight coefficient of each sampling point needs to be accurately calculated in advance to reduce the influence of noise, and then the nonlinear optimization equation is constructed according to the weight coefficients of all the sampling points, thereby not only adapting to the determination of the effective imaging area of the fisheye image shot in different scenes, with relatively strong robustness, but also ensuring the determination accuracy of the effective imaging area of the fisheye image.

Additional aspects and advantages of the embodiments of this application will be set forth in part in the description below, and will become apparent in part from the description below, or may be learned by practice of the embodiments of this application.

### BRIEF DESCRIPTION OF THE DRAWINGS

The foregoing and/or additional aspects and advantages of this application will become apparent and readily understood from the description of the embodiments in conjunction with the following accompanying drawings, in which:

FIG. 1 is a schematic flow diagram of a fisheye image processing method according to an embodiment of this application;

FIG. 2 is a schematic scene diagram of the fisheye image processing method according to an embodiment of this application;

FIG. 3 is a schematic flow diagram of the fisheye image processing method according to an embodiment of this application;

FIG. 4 is a schematic flow diagram of the fisheye image processing method according to an embodiment of this application;

FIG. 5 is a schematic flow diagram of the fisheye image processing method according to an embodiment of this application;

FIG. 6 is a schematic flow diagram of the fisheye image processing method according to an embodiment of this application;

FIG. 7 is a schematic structural diagram of an electronic device according to an embodiment of this application; and

FIG. 8 is a schematic diagram of a connection state of a non-volatile computer-readable storage medium and a processor according to an embodiment of this application.

### DETAILED DESCRIPTION

The embodiments of this application will be described in detail below, and examples of the embodiments are illustrated in the accompanying drawings, wherein the same or similar reference numerals indicate the same or similar elements or the elements having same or similar functions throughout the drawings. The embodiments described below with reference to the accompanying drawings are exemplary only to explain the embodiments of this application and should not be construed as limiting the embodiments of this application.

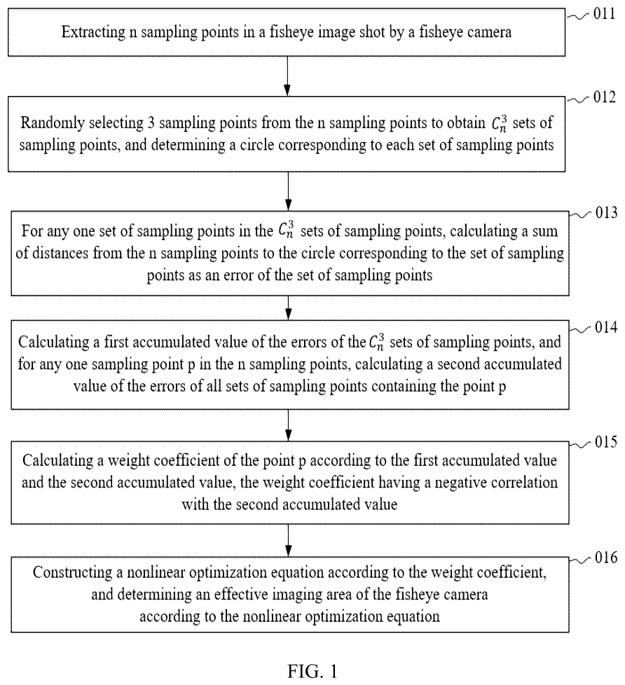

With reference to FIG. 1, an embodiment of this application provides a fisheye image processing method, the method including:
step 011: extracting n sampling points in a fisheye image shot by a fisheye camera;
wherein the fisheye image may be an original image collected by the fisheye camera, or the fisheye image is an image obtained by preprocessing the original image through edge detection, image binarization, and the like.

The sampling points are pixels satisfying the requirements in the fisheye image, for example, the sampling points are pixels with pixel values greater than a preset pixel value threshold in the fisheye image; or the fisheye image is a binary image, the pixel values of the pixels include 0 and 1, and the sampling points are pixels with the pixel values being 1 in the fisheye image.

After extracting n (n being an integer) sampling points in the fisheye image, for the convenience of subsequent calculation, image coordinates of the n sampling points in the fisheye image may be acquired.

Step 012: randomly selecting 3 sampling points from the n sampling points to obtain Cₙ³ sets of sampling points, and determining a circle corresponding to each set of sampling points.

The image coordinates of the sampling points are used for representing positions of the sampling points in the fisheye image, for example, an image coordinate system is established with a preset position (such as an upper left corner, an upper right corner and a center) of the fisheye image as a coordinate origin, so as to determine the image coordinates of the sampling points in the image coordinate system according to the positions of the sampling points in the fisheye image.

The effective imaging area of the fisheye camera is circular, and therefore when calculating the error of each sampling point, any 3 sampling points may be selected as one set of sampling points. If there are n sampling points, Cₙ³ (namely n!/[3!×(n−3)!]) sets of sampling points may be determined, and if there are 5 sampling points, C₅³ is 5!/[3!×(5−3)!]=10.

Each set of sampling points includes 3 sampling points, and one circle may be determined by the 3 sampling points. For example, the circle corresponding to each set of sampling points is determined according to the image coordinates of the 3 sampling points of each set of sampling points.

Step 013: for any one set of sampling points in the Cₙ³ sets of sampling points, calculating a sum of distances from the n sampling points to the circle corresponding to the set of sampling points as an error of the set of sampling points.

After determining the circle corresponding to each set of sampling points, the sum of distances from the n sampling points to the circle corresponding to each set of sampling points as the error of each set of sampling points. It can be understood that the closer the circle determined by the set of sampling points is to the effective imaging area of the fisheye camera, the more the sampling points on the circle determined by the set of sampling points are, and the smaller the distances between sampling points outside the set of sampling points and the circle determined by the set of sampling points are. Therefore, the sum of the distances from the n sampling points to the circle corresponding to the set of sampling points may be taken as the error of the set of sampling points, the greater the error of the set of sampling points is, the greater the deviation between the circle corresponding to the set of sampling points and the effective imaging area of the fisheye camera is, and the greater the possibility that the 3 sampling points in the set of sampling points are noisy points is.

For example, the distance from the sampling point to the circle corresponding to the set of sampling points may be an absolute value of a difference value between the distance from the sampling point to the center of circle corresponding to the set of sampling points and the radius of the circle corresponding to the set of sampling points. If 5 sampling points are included, namely, a sampling point a1 (x1, y1), a sampling point a2 (x2, y2), a sampling point a3 (x3, y3), a sampling point a4 (x4, y4) and a sampling point a5 (x5, y5) respectively, a circle R1 is determined by a set of sampling points A1 (including the sampling point a1, the sampling point a2 and the sampling point a3). In this case, the distance from each of the sampling points a1 to a5 to the circle R1 may be calculated, for example, firstly the distance from each of the sampling points a1 to a5 to the center of circle R1is calculated, the distance from the sampling point a1 to the center (x_{A1}, y_{A1}) of the circle R1 is d1=\sqrt{(x1−x_{A1})²−(y1−y_{A1})²}, the distance from the sampling point a2 to the center (x_{A1}, y_{A1}) of the circle R1 is calculated by d2=\sqrt{(x2−x_{A1})²−(y2−y_{A1})²}, the distance from the sampling point a3 to the center (x_{A1}, y_{A1}) of the circle R1 is calculated by d3=\sqrt{(x3−x_{A1})²−(y3−y_{A1})²}, the distance from the sampling point a4 to the center (x_{A1}, y_{A1}) of the circle R1 is calculated by d4=\sqrt{(x4−x_{A1})²−(y4−y_{A1})²}, and the distance from the sampling point a5 to the center of circle R1 is calculated by d5=\sqrt{(x5−x_{A1})²−(y5−y_{A1})²}. Then the absolute value of the difference value between the distance from each of the sampling points a1 to a5 to the center of circle R1 and the radius r of the circle R1 is respectively calculated to respectively determine the distance from each of the sampling points a1 to a5 to the circle R1. For example, the absolute value |d1−r| of the difference value between the distance d1 and the radius r of the circle R1,the absolute value |d2−r| of the difference value between the distance d2 and the radius r of the circle R1, the absolute value |d3−r| of the difference value between the distance d3 and the radius r of the circle R1, the absolute value |d4−r| of the difference value between the distance d4 and the radius r of the circle R1, and the absolute value |d5−r| of the difference value between the distance d5 and the radius r of the circle R1 are calculated, and thus the sum of the distance |d1−r| from the sampling point a1 to the circle R1, the distance |d2−r| from the sampling point a2 to the circle R1, the distance |d3−r| from the sampling point a3 to the circle R1, the distance |d4−r| from the sampling point a4 to the circle R1, and the distance |d5−r| from the sampling point a5 to the circle R1 is taken as the error of the set of sampling points A1. For the errors of other sets of sampling points, the errors are calculated in a way similar to the way in which the error of the set of sampling points A1 is calculated, which is not described in detail herein.

Step 014: calculating a first accumulated value of the errors of the Cₙ³ sets of sampling points, and for any one sampling point p in the n sampling points, calculating a second accumulated value of the errors of all sets of sampling points containing the point p.

In order to determine the probability that each sampling point is noise more accurately, firstly the first accumulated value of the errors of the Cₙ³ sets of sampling points may be determined as a total error; and for any one sampling point p in the n sampling points, since the point p may be located in a plurality of sets of sampling points, the second accumulated value of the errors of all sets of sampling points containing the point p may be calculated.

Step 015: calculating a weight coefficient of the point p according to the first accumulated value and the second accumulated value, the weight coefficient having a negative correlation with the second accumulated value.

After determining the first accumulated value and the second accumulated value of any one sampling point p, the weight coefficient of the point p may be determined by the second accumulated value of the point p and the first accumulated value. For example, the greater the ratio of the second accumulated value of the point p to the first accumulated value is, the greater the deviation between the circle corresponding to the set of sampling points in which the point p is located and the effective imaging area of the fisheye camera is, so that the possibility that the point p is noise may be accurately determined. For example, the greater the second accumulated value of the point p is, the greater the possibility that the point p is noise is, and the smaller the weight coefficient of the point p is. Namely, the weight coefficient of the sampling point has a negative correlation with the second accumulated value of the sampling point. The smaller the weight coefficient of the point p is, the less the influence of the point p on the subsequent determination of the effective imaging area of the fisheye camera is, thereby reducing the influence of the sampling point which may be noise on the determination accuracy of the effective imaging area of the fisheye camera.

For example, the weight coefficient of the point p is calculated by the following formula: W_{P}=1−ΣF_{P}/ΣF, wherein W_{P} is the weight coefficient of the point p, ΣF is the first accumulated value, and ΣF_{P} is the second accumulated value. In this way, the sum of the weight coefficients of all the sampling points may be 1, and the negative correlation between the second accumulated value of the sampling points and the weight coefficients is achieved.

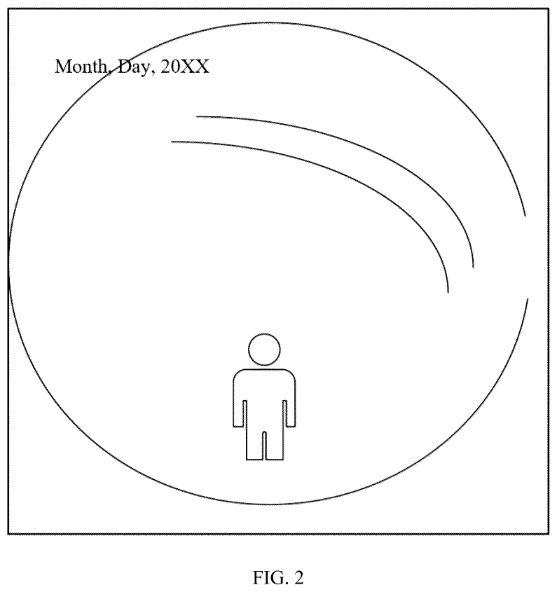

With reference to FIG. 2, after delivery, due to the situations that dust exists at an edge of a lens of the fisheye camera, Over Screen Display (OSD) contents (such as “Month, Day, 20XX” in FIG. 2) need to be added to the image shot after delivery, brightness of a shooting scene is non-uniform, and the like in the process of use, a lot of noise (such as the OSD contents and a part inside the circular area in FIG. 2) exists inside and outside a boundary of the effective imaging area, and burrs exist at the edge of the lens of the fisheye camera, so that a boundary loss (such as a notch in the circle in FIG. 2) is caused, thereby affecting the determination accuracy of the effective imaging area. Therefore, for the above scenes, in order to ensure the determination accuracy of the effective imaging area, screening needs to be correspondingly performed to remove noise, for example, for the OSD contents, an OSD area needs to be artificially marked for removal. If dust exists at the edge of the lens, an edge detection algorithm needs to be adjusted to accurately detect the boundary, and the like. That is to say, for different scenes, corresponding algorithms need to be set to ensure the accuracy of the effective imaging area of the fisheye image. Moreover, the algorithms cannot adapt to different scenes, the accuracy of the effective imaging area of the fisheye image in different scenes cannot be ensured, and the robustness is relatively poor.

However, in different scenes, according to this application, after acquiring the fisheye image, the sampling points do not need to be screened, and the weight coefficient of each sampling point is determined based on the second accumulated value of the errors of the set of sampling points of each sampling point and the first accumulated value of the errors of all the sets of sampling points, the greater the possibility that the sampling point is noise is, the smaller the weight coefficient of the sampling point is, thereby reducing the influence brought about by the noise, ensuring the accuracy of the effective imaging area of the fisheye image calculated subsequently, adapting to the fisheye images in different scenes, and having relatively strong robustness.

Step 016: constructing a nonlinear optimization equation according to the weight coefficient, and determining an effective imaging area of the fisheye camera according to the nonlinear optimization equation. In the embodiment of this application, the anti-distortion correction for the fisheye camera is performed in the process of shooting images according to the effective imaging area of the fisheye camera.

Specifically, after obtaining the weighting coefficient of any one sampling point p, the nonlinear optimization equation may be constructed based on the weighting coefficient of the point p.

The effective imaging area of the fisheye camera is circular, and therefore, in order to determine the effective imaging area of the fisheye camera, the center of circle (namely the optical center) and the radius of the effective imaging area need to be determined. Therefore, when constructing the nonlinear optimization equation, preset parameters to be solved in the nonlinear optimization equation include the image coordinate of the center of circle and the radius of the effective imaging area. In this way, subsequent determination of the effective imaging area according to the nonlinear optimization equation may be facilitated.

For example, a nonlinear optimization error equation may be constructed based on the image coordinate and the weight coefficient of each sampling point, and the preset parameters to be solved, so as to determine the effective imaging area by the nonlinear optimization error equation. For example, the nonlinear optimization equation is constructed according to the following formula: C(x, y, R)=Σ_{P=1}ⁿW_{P}*[(x_{P}−x)²+(y_{P}−y)²−R²], wherein (x_{P}, y_{P}) is the image coordinate of the point p, (x, y) is the image coordinate of the center of circle of the effective imaging area, W_{P} is the weight coefficient of the point p, and R is the radius of the effective imaging area.

Wherein optimal solutions of the nonlinear optimization equation are values of the preset parameters to be solved when enabling the function value of the nonlinear optimization equation is minimum, and when the function value of the nonlinear optimization equation is minimum, the optimal solutions of the nonlinear optimization equation may be determined.

After the construction of the nonlinear optimization equation is finished, the nonlinear optimization equation may be solved to obtain the optimal solutions of the nonlinear optimization equation. For example, each parameter to be solved of the nonlinear optimization equation is differentiated to determine the optimal solution for each parameter to be solved. After the optimal solution is determined, the optimal solution includes the radius and the image coordinate of the center of circle of the effective imaging area, so as to determine the effective imaging area of the fisheye image.

For the fisheye image processing method according to the embodiment of this application, by extracting n sampling points in the fisheye image, and then taking any 3 sampling points in the n sampling points as a set, Cₙ³ sets of sampling points are determined, and a circle corresponding to each set of sampling points is determined; an error corresponding to each set of sampling points may be determined by calculating a sum of distances from the n sampling points to the circle corresponding to each set of sampling points; and then by determining a first accumulated value of the errors of the Cₙ³ sets of sampling points, and a second accumulated value of the errors of all sets of sampling points containing any one sampling point p in the n sampling points, a weight coefficient of any one sampling point p is determined.

It can be understood that since noise points containing OSD are generally at edges of the effective imaging area (circle) of the fisheye camera or at corners of the image, these sampling points at the edges or the corners are obviously farther from most of the sampling points in the image (such as the sampling points in the effective imaging area), and the farther one sampling point is from other sampling points, the greater the possibility that the sampling point is noise is.

Therefore, the greater the second accumulated value of the sampling point p is, the farther the sampling point p is from other sampling points, and the smaller the weight coefficient of the sampling point p is. By determining the weight coefficient of any one sampling point p in advance, the influence of the sampling point which may be noise in the fisheye image is reduced, and thus the nonlinear optimization equation for determining the effective imaging area of the fisheye image is constructed based on the weight coefficient of each sampling point, and the effective imaging area of the fisheye image may be accurately obtained by calculating the optimal solution for the nonlinear optimization equation. In this way, compared with the case where it is difficult to accurately screen target sampling points which can be used for accurately calculating the effective imaging area in all the sampling points in different scenes, in this application, the sampling points do not need to be screened, only the weight coefficient of each sampling point needs to be accurately calculated in advance to reduce the influence of noise, and then the nonlinear optimization equation is constructed according to the weight coefficients of all the sampling points, thereby not only adapting to the determination of the effective imaging area of the fisheye image shot in different scenes, with relatively strong robustness, but also ensuring the determination accuracy of the effective imaging area of the fisheye image.

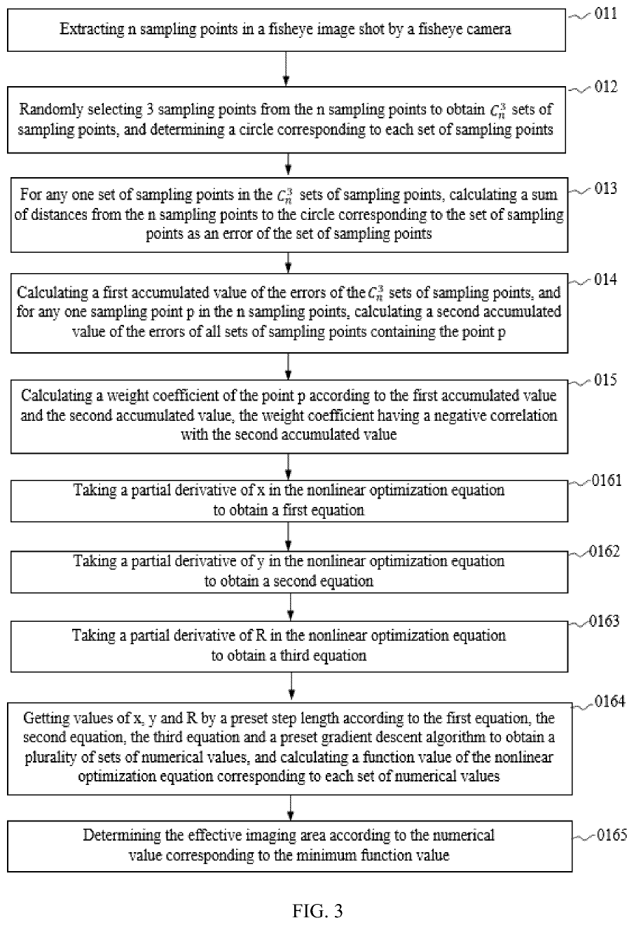

With reference to FIG. 3, step 016: constructing a nonlinear optimization equation according to the weight coefficient, includes:

step 0161: taking a partial derivative of x in the nonlinear optimization equation to obtain a first equation;

step 0162: taking a partial derivative of y in the nonlinear optimization equation to obtain a second equation;

step 0163: taking a partial derivative of R in the nonlinear optimization equation to obtain a third equation;

step 0164: getting values of x, y and R by a preset step length according to the first equation, the second equation, the third equation and a preset gradient descent algorithm to obtain a plurality of sets of numerical values, and calculating a function value of the nonlinear optimization equation corresponding to each set of numerical values; and

step 0165: determining the effective imaging area according to the numerical value corresponding to the minimum function value.

Specifically, after determining the nonlinear optimization equation, for example, after constructing the nonlinear optimization error equation C(x, y, R)=Σ_{P=1}ⁿW_{P}*[(x_{P}−x)²+(y_{P}−y)²−R²], in this case, the nonlinear optimization error equation may be solved to obtain the optimal solution for the nonlinear optimization error equation, wherein (x_{P}, y_{P}) is the image coordinate of the point p, (x, y) is the image coordinate of the center of circle of the effective imaging area, W_{P} is the weight coefficient of the point p, and R is the radius of the effective imaging area.

The image coordinate of the center of circle of the effective imaging area is (x, y), and adjustment directions of x, y and R when enabling the function value of the nonlinear optimization equation to be decreased may be determined by taking partial derivatives of x, y and R, so as to select x, y and R according to the adjustment directions of x, y and R by iteration to obtain a plurality of sets of x, y and R, so that a set of x, y and R which enables the function value of the nonlinear optimization equation to be minimum is obtained as the optimal solution, and the effective imaging area of the fisheye camera may be determined according to the optimal solution.

For example, the adjustment direction of x may be determined by the first equation

$$\frac{\partial C ( x , y , R )}{\partial x}$$

obtained by taking a partial derivative of x; the adjustment direction of y may be determined by the second equation

$$\frac{\partial C ( x , y , R )}{\partial y}$$

obtained by taking a partial derivative of y; and the adjustment direction of R may be determined by the third equation

$$\frac{\partial C ( x , y , R )}{\partial R}$$

obtained by taking a partial derivative of R.

In this case, values of x, y and R are got by a preset step length according to the first equation, the second equation, the third equation and a preset gradient descent (GD) algorithm to obtain a plurality of sets of numerical values, for example, the preset step length of x is 1, 2, and the like, the preset step length of y is 1, 2, and the like, and the preset step length of R is 1, 2, and the like. Each set of numerical values includes x, y and R, the function value of the nonlinear optimization equation corresponding to each set of numerical values may be calculated, as the values continue to be gotten, the function value of the nonlinear optimization equation is continuously decreased until a plurality of function values of the nonlinear optimization equation obtained by getting the values again substantially remain unchanged (for example, the difference value of the plurality of function values is less than a preset difference value threshold), or a plurality of function values of the nonlinear optimization equation obtained by getting the values again are increased, and a set of numerical values which enables the value of the nonlinear optimization equation to be minimum may be determined as the optimal solution.

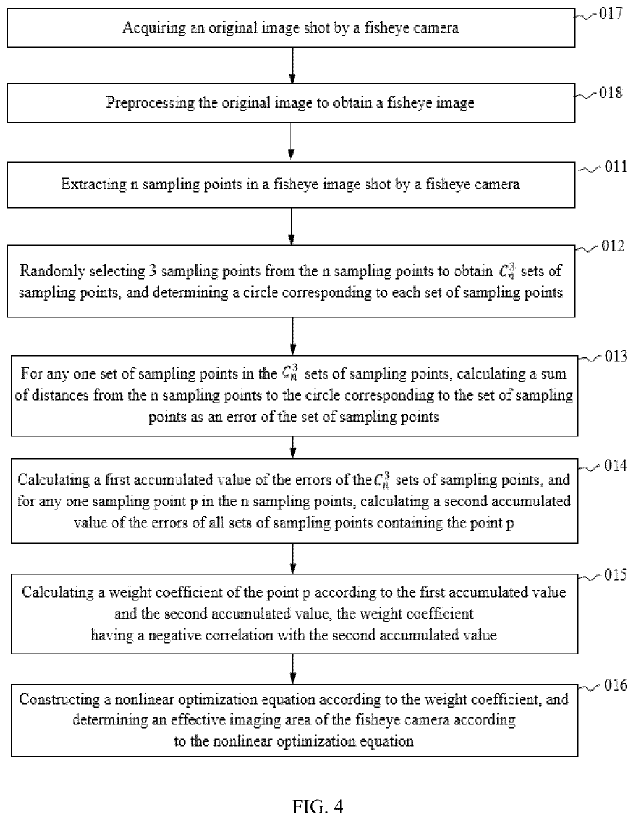

With reference to FIG. 4, before step 011: extracting n sampling points in a fisheye image shot by a fisheye camera, the fisheye image processing method further includes:
step 017: acquiring an original image shot by the fisheye camera; and
step 018: preprocessing the original image to obtain the fisheye image, the preprocessing including edge detection and image binarization.

Specifically, when the fisheye camera is used for shooting, the original image is firstly generated, and after acquiring the original image shot by the fisheye camera, the original image may be preprocessed. It can be understood that the original image contains targets such as objects and people of a scene, and when determining the effective imaging area, it is generally necessary to determine a boundary of the original image and determine the effective imaging area by utilizing pixels of the boundary of the original image, and therefore the original image needs to be preprocessed to filter a large number of pixels without texture areas, so as to retain the pixels near the boundary as much as possible.

For example, preprocessing the original image may be performing edge detection on the original image (for example, detecting an edge pixel in the original image based on a preset edge detection algorithm), and then performing image binarization processing to obtain the fisheye image mainly containing the edge pixel. After the image binarization, for the edge pixel, it is determined that the pixel value is 1, and for other pixels, it is determined that the pixel value is 0. In this case, n sampling points in the preprocessed original image (namely the fisheye image) may be extracted.

It can be understood that in the fisheye image obtained after preprocessing the original image, in addition to the edge pixel of the boundary of the effective imaging area, background noise may be distributed inside and outside the boundary, such as the edge pixel of the object, the pixel of the OSD area, and the like, and these pixels are all taken as subsequent sampling points to participate in the determination of the effective imaging area, so as to adapt to the determination of the effective imaging area of the fisheye image obtained in any scene.

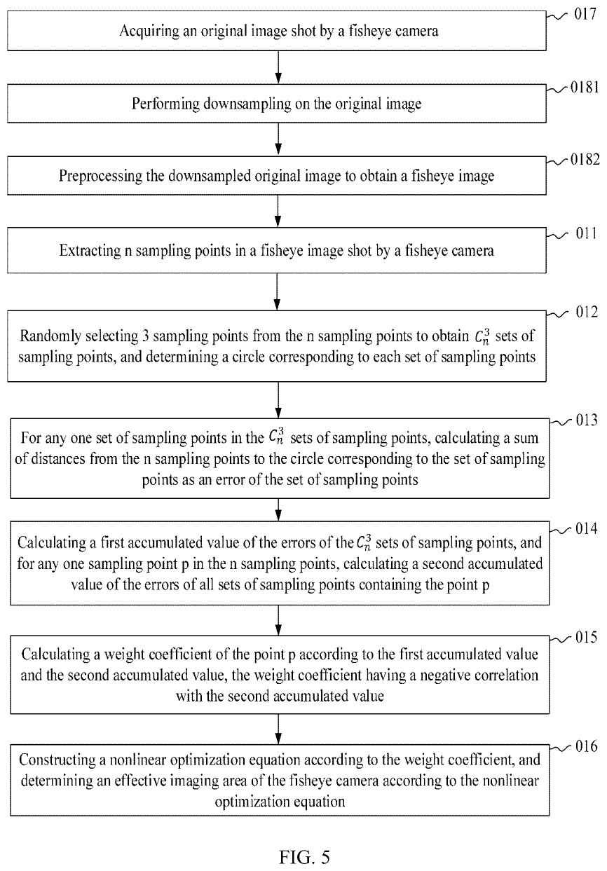

With reference to FIG. 5, step 018: preprocessing the original image to obtain a fisheye image, includes:
step 0181: performing downsampling on the original image; and
step 0182: preprocessing the downsampled original image to obtain the fisheye image.

Specifically, after the original image is acquired, in order to reduce the calculation amount for the subsequent determination of the effective imaging area, downsampling may be firstly performed on the original image, and the downsampling may reduce the number of sampling points. For example, after performing downsampling on the original image according to a sampling coefficient k, a ratio of the size of the downsampled original image to the size of the original image before the downsampling is 1/(k+1)². For example, for an N*M image, if the downsampling coefficient is k, one image is formed by taking one pixel at intervals of k pixels in every row and every column in the original image, so as to achieve the downsampling of the image, and the size of the downsampled image becomes (N*M)/(k+1)². It should be explained that k+1 may be a common divisor of N and M to ensure the accuracy of the size of the downsampled image (namely (N*M)/(k+1)²).

It can be understood that when the size of the original image is too large, there will be too many sampling points in the preprocessed original image, and in order to reduce the calculation amount for calculating the effective imaging area, it is necessary to reduce the number of the extracted sampling points. Therefore, downsampling may be performed on the original image, if the fisheye image is a 1,000*1,000 image, and the downsampling coefficient is 1, one image is formed by taking one pixel at intervals of 1 pixel in every row and every column in the original image as the downsampled original image, and the downsampled original image becomes 500*500. In this way, by performing downsampling on the original image, the pixels of the downsampled original image are reduced, so that the number of sampling points extracted in the fisheye image is reduced to reduce the calculation amount for calculating the effective imaging area.

After the downsampled original image is acquired, the downsampled original image may be preprocessed (namely, edge detection, image binarization, and the like), so as to obtain the fisheye image.

This application aims at acquiring the effective imaging area of the fisheye camera, and the effective imaging area of the fisheye camera is the effective imaging area of the fisheye image before the downsampling, while after performing downsampling on the fisheye image, the size of the fisheye image is different from the size before the downsampling. Therefore, the effective imaging area of the fisheye image is obviously also different from the effective imaging area of the fisheye image before the downsampling, and therefore the effective imaging area of the fisheye image may be restored according to the sampling coefficient for downsampling to determine the effective imaging area of the fisheye camera. For example, if the sampling coefficient is 1, the radius of the effective imaging area of the fisheye image is R, and the center of circle of the effective imaging area is (x, y), it can be understood that the center of circle of the effective imaging area is substantially unchanged, the radius is changed, the center of circle of the effective imaging area of the fisheye camera may be determined to be (x, y), and the radius of the effective imaging area of the fisheye camera is 2R, namely, the radius of the effective imaging area of the fisheye camera=(the sampling coefficient+1)*the radius of the effective imaging area of the fisheye image, so as to determine the effective imaging area of the fisheye camera.

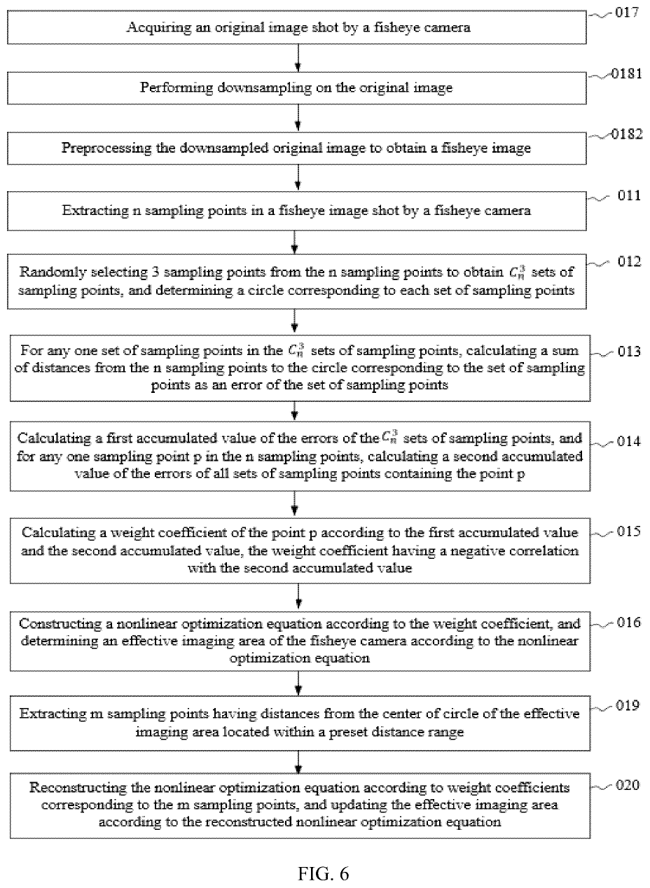

With reference to FIG. 6, after step 016: constructing a nonlinear optimization equation according to the weight coefficient, and determining an effective imaging area of the fisheye camera according to the nonlinear optimization equation, the fisheye image processing method further includes:
step 019: extracting m sampling points having distances from the center of circle of the effective imaging area located within a preset distance range; and
step 020: reconstructing the nonlinear optimization equation according to weight coefficients corresponding to the m sampling points, and updating the effective imaging area according to the reconstructed nonlinear optimization equation. In the embodiment of this application, the anti-distortion correction for the fisheye camera is performed in the process of shooting images according to the effective imaging area of the fisheye camera.

Specifically, the sampling points near the boundary of the effective imaging area of the fisheye image may be further screened to correct the effective imaging area of the fisheye image. The sampling points near the boundary of the effective imaging area may be m (m is an integer) sampling points having distances from the center of circle of the effective imaging area of the fisheye image located within the preset distance range, if the radius of the effective imaging area of the fisheye image is R, m sampling points having distances from the center of circle of the effective imaging area of the fisheye image located near the radius R may be acquired, for example, the preset distance range is (R±1), (R±2), and the like. In this way, the m sampling points near the boundary of the effective imaging area of the fisheye image may be extracted to reconstruct the nonlinear optimization equation by more accurate image coordinates and weight coefficients of the m sampling points, in this case, the optimal solution for the reconstructed nonlinear optimization equation is calculated, namely, the effective imaging area of the fisheye camera may be updated according to the redetermined optimal solution, thereby improving the accuracy of the finally determined effective imaging area of the fisheye camera, wherein the way of calculating the optimal solution for the reconstructed nonlinear optimization equation is substantially similar to the way of calculating the optimal solution for the nonlinear optimization equation, which is not described in detail herein.

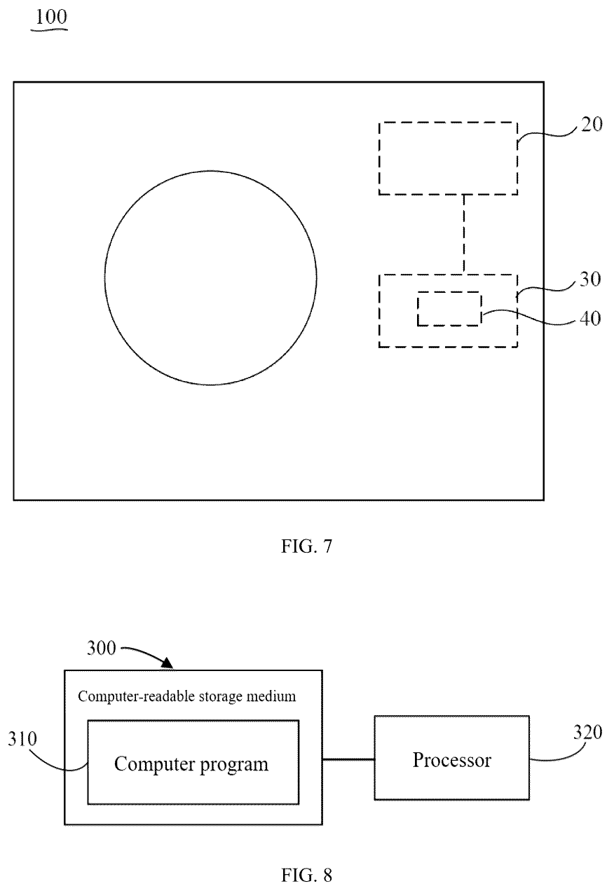

With reference to FIG. 7, the electronic device 100 according to the embodiment of this application includes one or more processors 20, a memory 30 configured to store one or more programs 40, wherein the one or more processors 20 is coupled to the memory, and the one or more computer programs 40 are stored in the memory 30 and executed by the one or more processors 20, and the computer programs 40 include a plurality of computer-readable instructions for executing the fisheye image processing method according to any one of the embodiments described above.

Wherein the electronic device 100 may be a fisheye camera or a back-end server device communicated with the fisheye camera, a mobile phone, a tablet computer, a notebook computer, a smart watch, and the like. As shown in FIG. 7, the embodiment of this application is described by taking the fisheye camera as the electronic device 100 for an example, and it can be understood that the electronic device 100 is not limited to the fisheye camera. That is to say, for the fisheye camera of this application, the effective imaging area may be determined based on the fisheye image after acquiring the fisheye image, thereby facilitating the anti-distortion correction of the fisheye camera at any time in the process of use.

With reference to FIG. 8, an embodiment of this application further provides a non-transitory computer-readable storage medium 300. The medium 300 stores a computer program 310 including a plurality of computer-readable instructions, wherein the computer program 310, when executed by a processor 320, implements the steps of the fisheye image processing method according to any one of the embodiments described above, which is not described in detail herein for brevity.

The skilled in the art can understand that the above-mentioned computer-readable instructions can be stored in a computer-readable storage medium, if the computer instructions are implemented in a form of software functional modules and sold or used as independent products. Based on this understanding, the technical solution of this application, in essence, or a part that contributes to the prior art, or all or part of the technical solution can be embodied in a form of a software product. A computer software product is stored in a storage medium, including several instructions for an electronic device (which can be a fisheye camera, a type of camera device, or a computing device, etc.) to perform all or part of the steps of the method described in each embodiment of this application. The aforementioned storage medium is a RAM, a memory, a read-only memory (ROM), an electrically programmable ROM (EPROM), an electrically erasable programmable ROM (EEPROM), a register, a hard disk, a removable magnetic disk, a CD-ROM, or any storage medium of other forms well-known in the technical field.

Any process or method description in a flowchart or otherwise described herein may be understood to represent a module, segment or portion including codes of one or more executable instructions for implementing the steps of a particular logical function or process, and the scope of the preferred embodiments of this application includes additional implementations, wherein functions may be executed in substantially the same way or in a reverse order, not in the order illustrated or discussed, including according to the functions referenced, as will be understood by those skilled in the art to which the examples of this application pertain.

Although the embodiments of this application have been illustrated and described above, it can be understood that the embodiments described above are exemplary and are not to be construed as limiting this application, and variations, modifications, substitutions and alterations may be made to the embodiments described above by those ordinarily skilled in the art within the scope of this application.

What is claimed is:

1. A fisheye image processing method, comprising:
extracting n sampling points in a fisheye image shot by a fisheye camera;
randomly selecting 3 sampling points from the n sampling points to obtain Cₙ³ sets of sampling points, and determining a circle corresponding to each set of sampling points;
for any one set of sampling points in the Cₙ³ sets of sampling points, calculating a sum of distances from the n sampling points to the circle corresponding to the set of sampling points as an error of the set of sampling points;
calculating a first accumulated value of the errors of the Cₙ³ sets of sampling points, and for any one sampling point p in the n sampling points, calculating a second accumulated value of the errors of all sets of sampling points containing the point p;
calculating a weight coefficient of the point p according to the first accumulated value and the second accumulated value, the weight coefficient having a negative correlation with the second accumulated value; and
constructing a nonlinear optimization equation according to the weight coefficient, and determining an effective imaging area of the fisheye camera according to the nonlinear optimization equation.

2. The fisheye image processing method according to claim 1, further comprising:
acquiring an original image shot by the fisheye camera; and
preprocessing the original image to obtain the fisheye image, the preprocessing comprising edge detection and image binarization.

3. The fisheye image processing method according to claim 2, wherein the preprocessing the original image to obtain the fisheye image, comprises:
performing downsampling on the original image; and
preprocessing the downsampled original image to obtain the fisheye image.

4. The fisheye image processing method according to claim 1, wherein the weight coefficient of the point p by the following formula: W_{P}=1−ΣF_{P}/ΣF, wherein W_{P} is the weight coefficient of the point p, ΣF is the first accumulated value, and ΣF_{P} is the second accumulated value.

5. The fisheye image processing method according to claim 1, wherein the nonlinear optimization equation is constructed according to the following formula: C(x, y, R)=Σ_{P=1}ⁿW_{P}*[(x_{P}−x)²+(y_{P}−y)²−R²], wherein (x_{P}, y_{P}) is an image coordinate of the point p, (x, y) is an image coordinate of a center of circle of the effective imaging area, W_{P} is the weight coefficient of the point p, and R is a radius of the effective imaging area.

6. The fisheye image processing method according to claim 5, wherein the determining an effective imaging area of the fisheye camera according to the nonlinear optimization equation, comprises:
taking a partial derivative of x in the nonlinear optimization equation to obtain a first equation;
taking a partial derivative of y in the nonlinear optimization equation to obtain a second equation;
taking a partial derivative of R in the nonlinear optimization equation to obtain a third equation;
getting values of x, y and R by a preset step length according to the first equation, the second equation, the third equation and a preset gradient descent algorithm to obtain a plurality of sets of numerical values, and calculating a function value of the nonlinear optimization equation corresponding to each set of numerical values; and
determining the effective imaging area according to the numerical value corresponding to the minimum function value.

7. The fisheye image processing method according to claim 1, further comprising:
extracting m sampling points having distances from the center of circle of the effective imaging area located within a preset distance range; and
reconstructing the nonlinear optimization equation according to weight coefficients corresponding to the m sampling points, and updating the effective imaging area according to the reconstructed nonlinear optimization equation.

8. An electronic device, comprising:
a memory configured to store a plurality of computer-readable instructions; and
a processor coupled to the memory and configured to read the computer-readable instructions, wherein the processor when executing the computer-readable instructions is further configured to:
extract n sampling points in a fisheye image shot by a fisheye camera;
randomly selecting 3 sampling points from the n sampling points to obtain Cₙ³ sets of sampling points, and determine a circle corresponding to each set of sampling points;
for any one set of sampling points in the Cₙ³ sets of sampling points, calculate a sum of distances from the n sampling points to the circle corresponding to the set of sampling points as an error of the set of sampling points;
calculate a first accumulated value of the errors of the Cₙ³ sets of sampling points, and for any one sampling point p in the n sampling points, calculate a second accumulated value of the errors of all sets of sampling points containing the point p;
calculate a weight coefficient of the point p according to the first accumulated value and the second accumulated value, the weight coefficient having a negative correlation with the second accumulated value; and
construct a nonlinear optimization equation according to the weight coefficient, and determine an effective imaging area of the fisheye camera according to the nonlinear optimization equation.

9. The electronic device according to claim 8, wherein the processor is further configured to:
acquire an original image shot by the fisheye camera; and
preprocess the original image to obtain the fisheye image, the preprocessing comprising edge detection and image binarization.

10. The electronic device according to claim 9, wherein the original image is preprocessed by means of:
performing downsampling on the original image; and
preprocessing the downsampled original image to obtain the fisheye image.

11. The electronic device according to claim 8, wherein the weight coefficient of the point p is calculated by the following formula: W_{P}=1−ΣF_{P}/ΣF, wherein W_{P} is the weight coefficient of the point p, ΣF is the first accumulated value, and ΣF_{P} is the second accumulated value.

12. The electronic device according to claim 8, wherein the nonlinear optimization equation is constructed according to the following formula: C(x, y, R)=Σ_{P=1}ⁿW_{P}*[(x_{P}−x)²+(y_{P}−y)²−R²], wherein (x_{P}, y_{P}) is an image coordinate of the point p, (x, y) is an image coordinate of a center of circle of the effective imaging area, W_{P} is the weight coefficient of the point p, and R is a radius of the effective imaging area.

13. The electronic device according to claim 12, wherein the effective imaging area of the fisheye camera is determined by means of:
taking a partial derivative of x in the nonlinear optimization equation to obtain a first equation;
taking a partial derivative of y in the nonlinear optimization equation to obtain a second equation;
taking a partial derivative of R in the nonlinear optimization equation to obtain a third equation;
getting values of x, y and R by a preset step length according to the first equation, the second equation, the third equation and a preset gradient descent algorithm to obtain a plurality of sets of numerical values, and calculating a function value of the nonlinear optimization equation corresponding to each set of numerical values; and
determining the effective imaging area according to the numerical value corresponding to the minimum function value.

14. The electronic device according to claim 8, wherein the processor is further configured to:
extract m sampling points having distances from the center of circle of the effective imaging area located within a preset distance range; and
reconstruct the nonlinear optimization equation according to weight coefficients corresponding to the m sampling points, and update the effective imaging area according to the reconstructed nonlinear optimization equation.

15. A non-transitory computer-readable storage medium having a plurality of computer-readable instructions stored thereon, wherein the computer-readable instructions, when executed by a processor of an electronic device, cause the electronic device to perform operations comprising:
extracting n sampling points in a fisheye image shot by the fisheye camera;
randomly selecting 3 sampling points from the n sampling points to obtain Cₙ³ sets of sampling points, and determining a circle corresponding to each set of sampling points;
for any one set of sampling points in the Cₙ³ sets of sampling points, calculating a sum of distances from the n sampling points to the circle corresponding to the set of sampling points as an error of the set of sampling points;
calculating a first accumulated value of the errors of the Cₙ³ sets of sampling points, and for any one sampling point p in the n sampling points, calculating a second accumulated value of the errors of all sets of sampling points containing the point p;
calculating a weight coefficient of the point p according to the first accumulated value and the second accumulated value, the weight coefficient having a negative correlation with the second accumulated value; and
constructing a nonlinear optimization equation according to the weight coefficient, and determining an effective imaging area of the fisheye camera according to the nonlinear optimization equation.

16. The non-transitory computer-readable storage medium according to claim 15, wherein the operations further comprise:
acquiring an original image shot by the fisheye camera; and
preprocessing the original image to obtain the fisheye image, the preprocessing comprising edge detection and image binarization.

17. The non-transitory computer-readable storage medium according to claim 16, wherein the original image is by preprocessed by means of:
performing downsampling on the original image; and
preprocessing the downsampled original image to obtain the fisheye image.

18. The non-transitory computer-readable storage medium according to claim 15, wherein the weight coefficient of the point p is calculated by the following formula: W_{P}=1−ΣF_{P}/ΣF, wherein W_{P} is the weight coefficient of the point p, ΣF is the first accumulated value, and ΣF_{P} is the second accumulated value.

19. The non-transitory computer-readable storage medium according to claim 15, wherein the nonlinear optimization equation is constructed according to the following formula: C(x, y, R)=Σ_{P=1}ⁿW_{P}*[(x_{P}−x)²+(y_{P}−y)²−R²], wherein (x_{P}, y_{P}) is an image coordinate of the point p, (x, y) is an image coordinate of a center of circle of the effective imaging area, W_{P} is the weight coefficient of the point p, and R is a radius of the effective imaging area.

20. The non-transitory computer-readable storage medium according to claim 15, wherein the operations further comprise:
extracting m sampling points having distances from the center of circle of the effective imaging area located within a preset distance range; and
reconstructing the nonlinear optimization equation according to weight coefficients corresponding to the m sampling points, and updating the effective imaging area according to the reconstructed nonlinear optimization equation.
